(19) United States
(12) Patent Application Publication
(10) Pub. No.: US 2019/0048721 A1
(43) Pub. Date: Feb. 14, 2019

(54) SCROLL PUMP TIP SEALING

(71) Applicant: Edwards Limited, Burgess Hill, West Sussex (GB)

(72) Inventors: Peter Charles Lamb, Burgess Hill, Sussex (GB); Peter David Jones, Burgess Hill, Sussex (GB)

(21) Appl. No.: 16/079,914

(22) PCT Filed: Feb. 22, 2017
(86) PCT No.: PCT/GB2017/050446

§ 371 Date: Aug. 24, 2018

(30) Foreign Application Priority Data
Feb. 26, 2016 (GB) 1603333.4

(51) Int. Cl. F01C 19/00; F04C 18/02; F04C 27/00

(52) U.S. Cl. CPC F01C 19/005; F04C 18/0207; F04C 27/005; F05C 2225/06; F05B 2280/4006; F05B 2280/5001; F05C 2251/02; F05B 2240/57

(57) ABSTRACT

A scroll pump tip seal to seal a single stage of a scroll pump that includes a first scroll and a second scroll. The tip seal is formed of a plurality of seal segments fitted contiguously end to end to a tip face the scroll wall of the scroll to form a continuous seal between the tip face and a base plate of the second scroll.

### CROSS-REFERENCE OF RELATED APPLICATION

This application is a Section 371 National Stage Application of International Application No. PCT/GB2017/050446, filed Feb. 22, 2017, which is incorporated by reference in its entirety and published as WO 2017/144870 A1, on Aug. 31, 2017 and which claims priority of British Application No. 1603333.4, filed Feb. 26, 2016.

### FIELD

The invention relates to scroll pump tip sealing.

### BACKGROUND

Known scroll compressors, or pumps, comprise a fixed scroll, an orbiting scroll and a drive mechanism for the orbiting scroll. The drive mechanism is configured to cause the orbiting scroll to orbit relative to the fixed scroll to cause pumping of a fluid between a pump inlet and a pump outlet. The fixed and orbiting scrolls each comprise an upstanding scroll wall extending from a generally circular base plate. Each scroll wall has an end, or tip, face disposed remote from and extending generally perpendicular to the respective base plate. The orbiting scroll wall is configured to mesh with the fixed scroll wall during orbiting of the orbiting scroll so that the relative orbital motion of the scrolls causes successive volumes of gas to be enclosed in pockets defined between the scroll walls and pumped from the inlet to the outlet.

A scroll pump may be a dry pump in which the scrolls are not lubricated so the internal working clearances are not sealed with a fluid such as oil. In this case, to prevent back leakage, the tip of each scroll wall is provided with a tip seal to seal against the base plate of the other scroll. The tip seals are located in channels defined in the tips of the scroll walls and are typically made of PTFE. There may be a small gap between the base of each channel and the opposing face of the tip seal so that, in use, fluid occupying the gap forces the tip seal towards and against the base plate of the other scroll. The tip seals close the gap between the scrolls caused by manufacturing and operating tolerances and reduce the leakage to an acceptable level.

Typically, a tip seal is narrower than its channel so that there is a radial clearance between the tip seal and the opposed sidewalls of the channel. During relative orbiting motion of the scrolls, the tip seal is urged against one sidewall for part of its motion and against the other sidewall for another part of its motion. As the tip seal moves back and forth between these positions, leakage is increased because there is a leakage path formed from one side of the seal to the other side of the seal. Known tip seals typically have an aspect ratio of height to radial width which is 1:1. That is, the radial width of the tip seal is equal to the height of the tip seal so that the tip seal has a square cross-section. Accordingly, the tip seal is relatively stiff in the radial, or widthways, direction. When the tip seal moves radially between the sidewalls of the tip seal channel, this relative stiffness slows the movement of the tip seal, thereby increasing leakage.

For some vacuum applications, such as those involving exposure to radioactivity, it is advantageous, or may even be essential, to use an oil free scroll pump. However, where there is to be exposure to radioactivity, it is not possible to use PTFE as the tip seal material.

The discussion above is merely provided for general background information and is not intended to be used as an aid in determining the scope of the claimed subject matter. The claimed subject matter is not limited to implementations that solve any or all disadvantages noted in the background.

### SUMMARY

The invention provides a scroll pump as specified in claim 1.

The invention also includes a scroll pump tip seal as specified in claim 15.

The invention also includes a method of providing a tip seal in a scroll pump as specified in claim 28.

The Summary is provided to introduce a selection of concepts in a simplified form that are further described in the Detail Description. This summary is not intended to identify key features or essential features of the claimed subject matter, nor is it intended. to be used as an aid in determining the scope of the claimed subject matter.

### BRIEF DESCRIPTION OF THE DRAWINGS

In the following disclosure, which is given by way of example only, reference will be made to the drawings, in which:

FIG. 1 is a schematic representation of a scroll pump;

FIG. 2 is a schematic plan view of the fixed scroll showing a first example of a tip sealing arrangement;

FIG. 3 is a cross section on line III-III in FIG. 2;

FIG. 4 is an enlargement of the central region of the fixed scroll shown in FIG. 2;

FIG. 5 is a view corresponding to FIG. 4 showing a second example of a tip sealing arrangement;

FIG. 6 is a view corresponding to FIG. 4 showing a third example of a tip sealing arrangement;

FIG. 7 is a view corresponding to FIG. 4 showing a fourth example of a tip sealing arrangement;

FIG. 8 is a view corresponding to FIG. 4 showing a fifth example of a tip sealing arrangement;

FIG. 9 shows a metal foam structure; and

FIG. 10 is a schematic side elevation of two seal segments.

### DETAILED DESCRIPTION

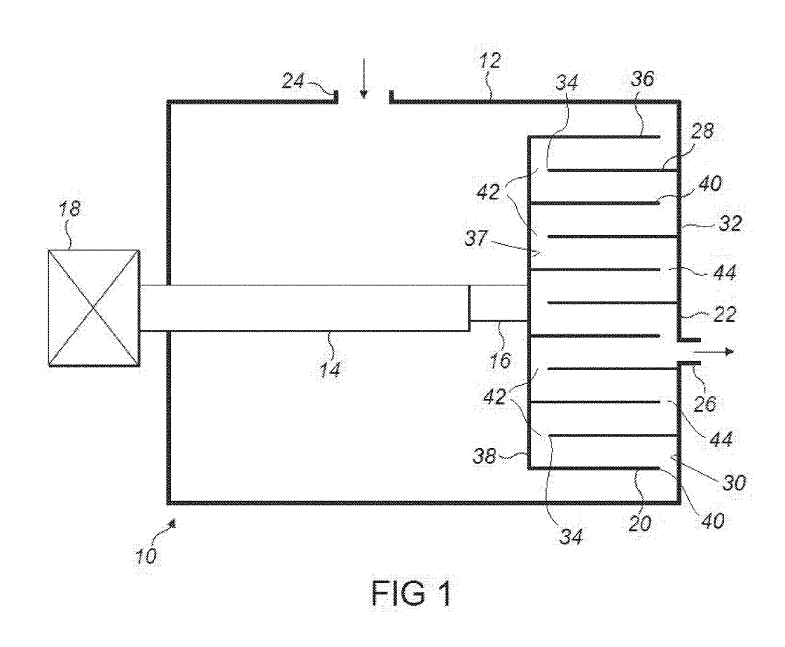

Referring to FIGS. 1 to 4, a scroll pump 10 comprises a pump housing 12 and a scroll driver that in this example comprises a drive shaft 14 having an eccentric shaft portion 16. The scroll driver is driven by a motor 18 that is connected with the drive shaft 14 and the eccentric shaft portion 16 is connected to an orbiting scroll 20 so that rotation of the drive shaft imparts an orbiting motion to the orbiting scroll relative to a fixed scroll 22 for pumping fluid along a fluid flow path between a pump inlet 24 and pump outlet 26.

The fixed scroll 22 comprises a spiralling, or involute, scroll wall 28. The scroll wall 28 extends perpendicularly from a major surface 30 of a generally circular base plate 32 and has an end, or tip, face 34 that is spaced from the major surface 30. The tip face 30 may be generally parallel to the major surface 30. The orbiting scroll 20 comprises a spiralling, or involute, scroll wall 36. The scroll wall 36 extends perpendicularly from a major surface 37 of a generally circular base plate 38 and has an end, or tip, face 40 that is spaced from the major surface 37. The tip face 40 may be generally parallel to the major surface 37. The orbiting scroll wall 36 co-operates, or meshes, with the fixed scroll wall 28 during orbiting movement of the orbiting scroll 20. Relative orbital movement of the scrolls 20, 22 causes successive volumes of gas to be trapped in pockets defined between the scrolls and pumped from the inlet 24 to the outlet 26.

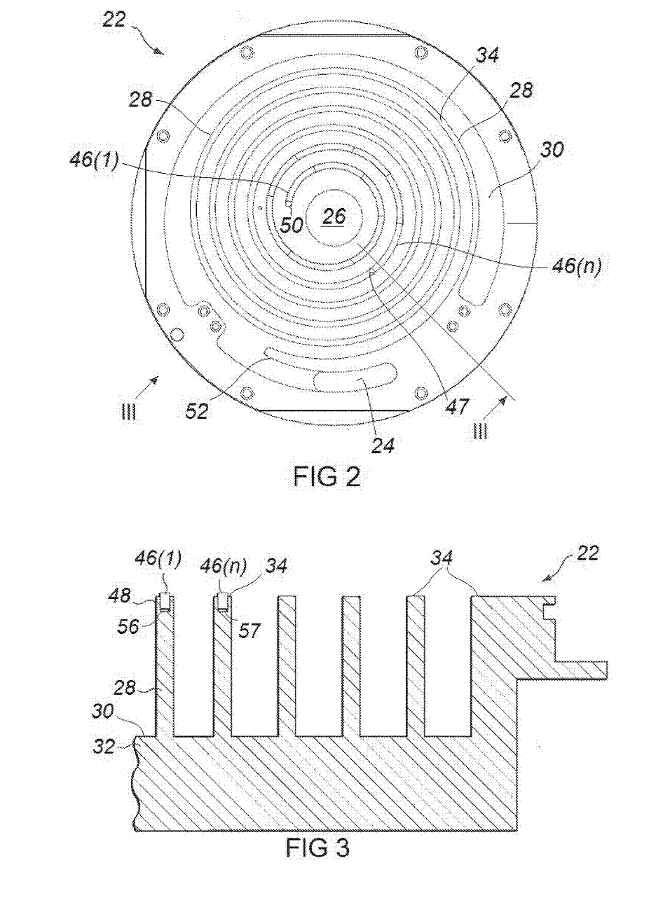

The scroll pump 10 may be a dry pump in which the scrolls 20, 22 are not lubricated so that there is no lubricant present to seal the working clearances between the scrolls. In order to prevent, or at least reduce, back leakage, via respective gaps 42, 44 between the tip faces 34, 40 of the scroll walls 28, 36 and the opposed major surfaces 30, 37 of the base plates 32, 38, respective tip sealing arrangements are provided to close the gaps 42, 44. The tip sealing arrangement for the fixed scroll 22 can be seen in FIGS. 2 to 4 and will be described in detail below. Although not shown in FIGS. 1 to 4, the tip sealing arrangement for the orbiting scroll 20 may be the same as, or similar to, the tip sealing arrangement of the fixed scroll 22.

Referring to FIGS. 2 to 4, the tip sealing arrangement for the fixed scroll 22 comprises a segmented tip seal 46(1) to 46(n) located in a channel 48 defined in the tip face 34 of the scroll wall 28. In some examples, the channel 48 may extend from the radially innermost end 50 of the scroll wall 28 to the radially outermost end 52 of the scroll wall. However, in the example illustrated by FIGS. 2 to 4, the channel 48 extends from the radially innermost end 50 of the scroll wall 28 to a position 47 intermediate the radially innermost and radially outermost ends 50, 52. From the end of the channel 48 disposed at the position 47 to the radially outermost end 52 of the scroll wall 28, the tip sealing arrangement may comprise the tip face 34 of the scroll wall without a tip seal. In examples in which a portion of the tip face 34 without a tip seal forms a part of the tip sealing arrangement, the tip face may be provided with one or more depressions defining pockets, recesses, grooves or serrations in the tip face for resisting leakage of fluid between the tip face and the opposed major surface 37 of the base plate 38. In examples in which a portion of the tip face 34 without a tip seal forms a part of the tip sealing arrangement, the segmented tip seal 46(1) to 46(n) is provided at the inner end of the scroll wall 28 and a tip seal omitted at the outer end of the scroll wall so that there is no tip seal in areas where the pressure of the pumped fluid will be relatively lower and a tip seal is present where the pressure will be relatively higher.

Referring to FIG. 3, there is a small gap 56 between the base 57 of the channel 48 and the facing side of the segmented tip seal 46(1) to 46(n) so that, in use, fluid occupying the gap may force the segmented tip seal towards the opposing major surface 37 of the base plate 38 of the orbiting scroll 20. Accordingly, the segmented tip seal 46(1) to 46(n) may be supported on a cushion of fluid which serves to urge the seal into sealing engagement with the major surface 37 of the base plate 38. Additionally, and although not shown in FIG. 3, there may be a radial clearance between the segmented tip seal 46(1) to 46(n) and the opposed sidewalk of the channel 48. During relative orbiting motion of the scrolls 20, 22, the segmented tip seal 46(1) to 46(n) is urged against one sidewall for part of its motion and against the other sidewall for another part of its motion.

As best seen in FIG. 4, the segmented tip seal comprises a plurality of seal segments 46(1) to 46(n) disposed contiguously end to end in the channel 48. The seal segments 46(1) to 46(n) are elongate bodies that have a first end 58 and a second end 60 disposed generally opposite the first end. In cross-section the seal segments 46(1) to 46(n) may be symmetric with respect to a centreline that extends between the first and second ends 58, 60 and may be at least substantially rectangular in cross section. The tip seal segments 46(1) to 46(n) may be curved in the lengthways direction of the elongate bodies. In this example the first and second ends 58, 60 each comprise a planar, or flat, end face. Although not essential, in the illustrated example the end faces are upright such that in use they extend at least substantially perpendicular to the base 57 of the channel 48. The first ends 58 of all but seal segment 46(1) are disposed in abutting face to face relationship with the respective opposed second ends 60 of the adjacent seal segment so that the seal segments 46(1) to 46(n) effectively define a substantially continuous tip seal having a length corresponding substantially to the sum of the respective lengths of the seal segments 46(1) to 46(n).

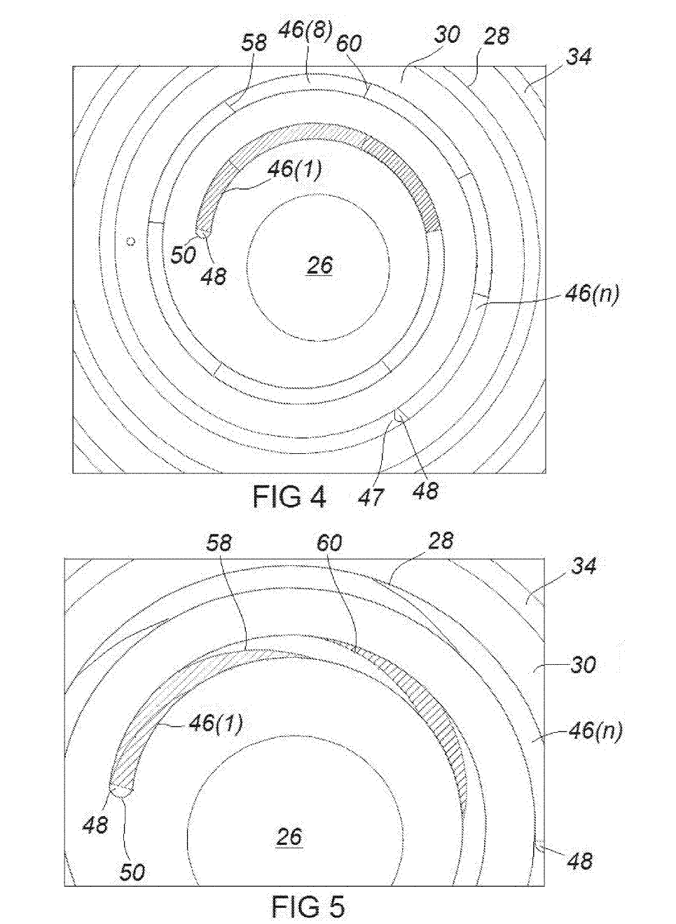

FIG. 5 is a view generally corresponding to FIG. 4 showing a second example of a tip seal comprising a plurality of seal segments 46(1) to 46(n) disposed contiguously end to end in the channel 48. In this example, all of the seal segments 46(1) to 46(n), except the seal segments 46(1) and 46(n), have respective first and second ends 58, 60 that comprise inclined end faces. The first end 58 of the first seal segment 46(1) and the second end 60 of the seal segment 46(n) may comprise an end face, for example an upright planar end face, configured to allow them to be fitted close to the respective ends of the channel 48. The first ends 58 of all but the seal segment 46(1) are disposed in abutting face to face overlapping relation with the respective opposed second ends 60 of the adjacent segments so that the segments effectively define a continuous tip seal. In this example, the second ends 60 are disposed in overlying relationship with the opposed adjacent first ends 58. In other examples, the configuration of the end faces may be such that when brought face to face the overlapping relationship is a side by side non-overlying relationship.

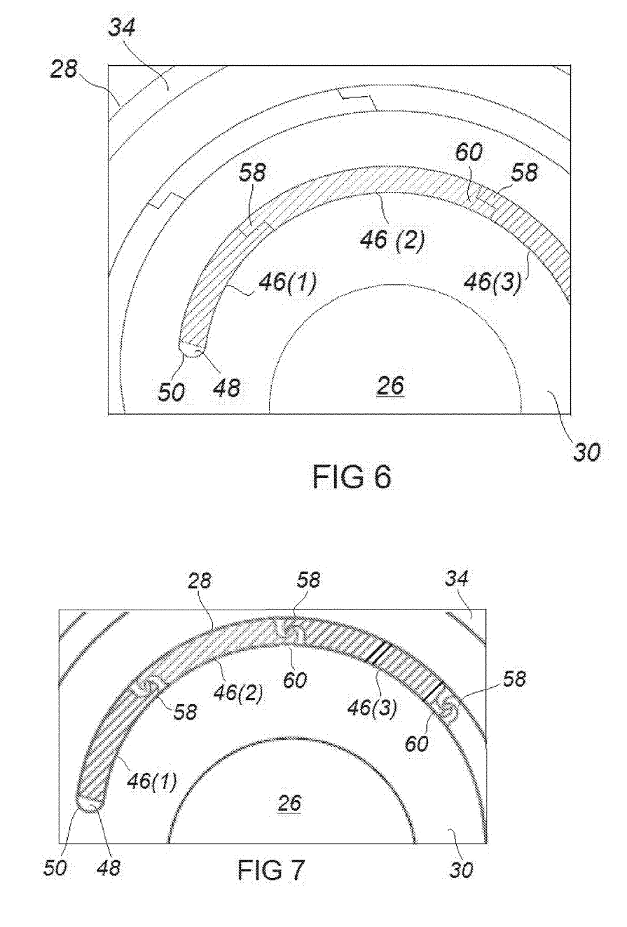

FIG. 6 is a view generally corresponding to FIG. 4 showing a third example of a tip seal comprising a plurality of seal segments 46(1), 46(2), 46(3) to 46(n) (segment 46(n) is not shown in FIG. 6) disposed contiguously end to end in the channel 48. In this example, all of the seal segments 46(1) to 46(n), except the seal segments 46(1) and 46(n), have first and second ends 58, 60 comprising respective end faces that are notched to define mating step formations. The first end 58 of the first seal segment 46(1) and the second end 60 of the seal segment 46(n) may comprise an end face, for example an upright planar end face, configured to allow them to be fitted close to the respective ends of the channel 48. The first ends 58 of all but the first seal segment 46(1) are disposed in abutting overlapping relationship with the respective opposed second ends 60 of the adjacent segment. Accordingly, the stepped formation at the first end 58 of the seal segment 46(2) overlaps the stepped formation at the second end 60 of the seal segment 46(1) and the stepped formation at the first end 58 of the seal segment 46(3) overlaps the stepped formation at the second end 60 of the seal segment 46(2) so that the seal segments 46(1) to 46(n) are arranged to form a substantially continuous tip seal.

Providing seal segments that are assembled in overlapping relationship as illustrated by way of example in FIGS. 5 and 6 allows the provision of a larger surface contact area, or interface, between adjacent segments than is obtained with a simple abutting relationship illustrated by the example shown in FIG. 4. The increased surface contact area between adjacent seal segments may reduce the potential for leakage between the seal segments. The overlap between adjacent segments may also accommodate some thermal expansion while maintaining sufficient sealing between the two scrolls 20, 22.

FIG. 7 is a view generally corresponding to FIG. 4 showing a fourth example of a tip seal comprising a plurality of seal segments 46(1), 46(2), 46(3) to 46(n) (segment 46(n) is not shown in FIG. 7) disposed contiguously end to end in the channel 48. In this example, all of the seal segments 46(1), 46(2), 46(3) to 46(n), except the seal segments 46(1) and 46(n), have first ends 58 and second ends 60 that comprise respective interengagable end formations that allow adjacent seal segments to be linked in a hinged, or articulated, end to end relationship to form a substantially continuous tip seal. The first end 58 of the first seal segment 46(1) and the second end 60 of the seal segment 46(n) may comprise an end face, for example an upright planar end face, configured to allow them to be fitted close to the respective ends of the channel 48. The connections made by the end formations are such that individual seal segments 46(1) to 46(n) cannot separate by relative movement in the lengthways direction of the tip seal. In the illustrated example, the end formations take the form of hooks or undercuts. Forming hinged, or hinge-like, connections between adjacent seal segments 46(1) to 46(n) may provide a tip seal with enhanced flexibility, thereby facilitating movement of the tip seal between the sidewalls of the channel 48 in response to the orbiting motion of the orbiting scroll 20 and so, potentially, reducing leakage below the tip seal.

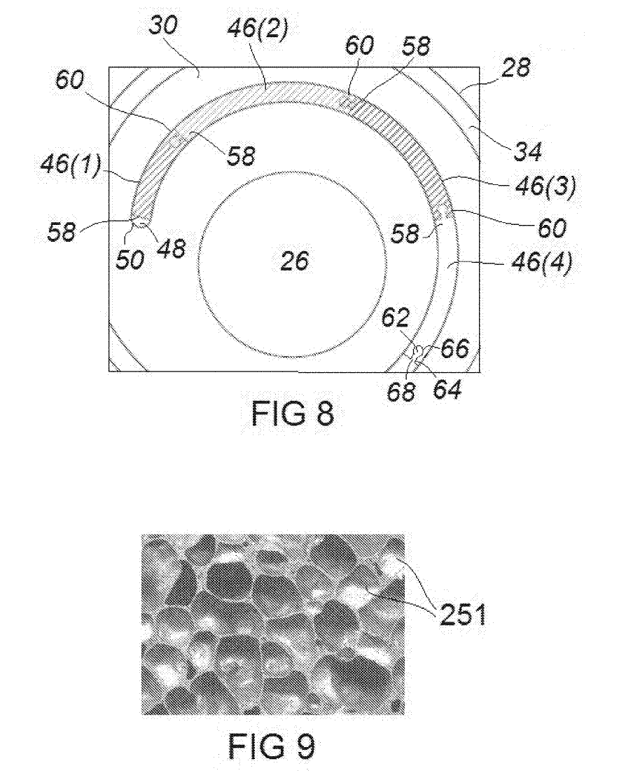

FIG. 8 is a view generally corresponding to FIG. 4 showing a fifth example of a tip seal comprising a plurality of seal segments 46(1), 46(2), 46(3) to 46(n) (segment 46(n) is not shown in FIG. 8) disposed contiguously end to end in the channel 48. in this example, all of the seal segments 46(1), 46(2), 46(3), 46(4) to 46(n), except the seal segments 46(1) and 46(n) have first ends 58 and second ends 60 that comprise respective interengagable end formations that allow adjacent seal segments to be linked in a contiguous end to end relationship to form a substantially continuous tip seal. The first end 58 of the first seal segment 46(1) and the second end 60 of the seal segment 46(n) may comprise an end face, for example an upright planar end face, configured to allow them to he fitted close to the respective ends of the channel 48. The configuration of the end formations is such that individual seal segments 46(1) to 46(n) cannot separate by relative movement in the lengthways direction of the tip seal. In this example, the end formations at the first ends 58 comprise projections that are insertable into mating recesses provided in the second ends 60. The projections may comprise a circular section leading end portion 62 connected with the main body of the seal segment 46(2) to 46(n) by a neck portion 64 and the recesses may comprise a circular section inner end portion 66 and a narrower channel 68 extending from the inner end portion to the end of the respective segment. The end formations may he configured such that they interengage by a relative movement in a direction transverse to the lengthways direction of the seal segments 46(1) to 46(n). In the illustrated example the end formations at the first ends 58 are insertable into the end formations at the second ends 60 by a relative movement that is at least substantially perpendicular to the longitudinal axes of the seal segments 46(1) to 46(n). The end formations may be configured to provide a press, or light interference, fit. Providing the seal segments with interengagable mating end formations that are a close fit with one another as illustrated by FIG. 8 allows the possibility of forming a positive connection between adjacent seal segments so that once assembled the seal segments may closely replicate a one-piece tip seal. The end formations may for example be configured such that no relative movement in the lengthways direction of the tip seal is allowed. Alternatively, or additionally, the end formations may be configured such that no relative lateral movement of the seal segments 46(1) to 46(n) is allowed.

Providing a segmented tip seal comprising a plurality of discrete seal segments that are fitted contiguously end to end in a channel, or groove, defined in the tip of a scroll wall may allow the use of relatively inflexible materials that would otherwise not be suitable for forming a tip seal. Furthermore, it may allow the use of materials that may be desirable for particular operating environments, but are not considered suitable for tip seal manufacture because processing them to form a tip seal would be difficult or wasteful of the bulk material. For example, tip seals are commonly made of PTFE, but PTFE is not a suitable material if the scroll pump is going to be exposed to radioactivity. Providing a tip seal as a plurality of seal segments allows the possibility of making the tip seal from polymer materials that have a higher flexural modulus than PTFE and can at least cope better than PTFE with exposure to radioactivity, or even the possibility of making the tip seal from a metal. As examples of suitable polymers, a segmented tip seal may be made of a polymer from the polyimide (PI), polyaryletherketone (PAEK), polysulfone (PSU) or polyamide-imide families. Examples of suitable family members of these high performance polymers include polyesteretherketone (PEEK) from the PAEK family, polyethersulfone (PES) from the PSU family and polyethermide (PEI) from the PI family. These polymers may have a flexural modulus which is at least 1.5 GPa, preferably greater than 2.0 GPa. For example, PEI may have a flexural modulus of 3.4 to 5.4 GPa, PES may have a flexural modulus of 3.4 to 5.6 GPa, VESPEL® from the family may have a flexural modulus of 3.7 to 20 GPa and PEEK may have a flexural modulus of 1.32 to 20 GPa. The polymers used may have a density that is lower than that of PTFE. For example, the density of the polymer used may be less than 1.6 g/cm³ and preferably less than 1.5 g/cm³. PEEK may have a density of 1.32 to 1.51 g/cm³, PEI and PES may have a density of 1.27 to 1.51 g/cm³ and VESPEL® may have a density of 1.37 to 1.54 g/cm³.

Since the segmented polymer tip seals may be operating in a dry environment, it may be desirable to add a filler such as graphite to the polymer material in order to provide a self-lubricating property.

A metal tip seal may be made of bronze, which has the advantage that bronze is a material approved for nuclear applications. Using bronze as the segmented tip seal material may also be desirable as bronze has self-lubricating, non-galling, properties, which may be advantageous since the tip seal will be in sliding contact with the opposite scroll. Other metals showing good non-galling properties that may be suitable for producing a segmented tip seal, perhaps in an alloy containing the metal, include cobalt, copper, gold, iridium, nickel, palladium, platinum, rhodium and silver.

As previously described, the tip seal may be provided only at the radially innermost end of the scroll walls and the portion of the tip face without a tip seal may form the remainder of the tip sealing arrangement. In other examples, a tip seal may be provided along at least substantially the entire length of the scroll wall. The seal segments may all have substantially the same length. Alternatively, different length seal segments may be provided. In examples in which different length seal segments are used, relatively short seal segments may be used at the radially innermost end of the scroll walls where the curvature of the scroll wall is greatest and relatively longer segments may be used as the curvature of the scroll wall decreases. In some examples, a single seal segment may be used for one or more of the radially outer turns of the scroll wall, while a plurality of seal segments is used for just one of the radially inner turns of the scroll wall. It may be advantageous to use relatively shorter length seal segments in at least some examples as using relatively longer length seal segments may require the provision of a larger number of seal segments with different curvature to take account of the changing curvature of the scroll wall. However, using relatively longer seal segments may be beneficial in reducing assembly times and reducing the number of potential leakage paths through the tip seal.

In some examples the seal segments may have a length in the range 20 to 100 mm, while in other examples the seal segments may have a length in the range 20 to 60 mm. In some examples, at least one of the seal segments may have a curved length in the range of 1 to 5% of the curved length of the tip face between the radially innermost and radially outermost ends 50, 52 of the scroll wall. In other examples, there may be at least one seal segment having a curved length in the range of 1 to 2% of the curved length of the tip face. In still other examples, at least one of the seal segments may have a curved length of about 1.5% of the curved length of the curved length of the tip face.

Each of the seal segments may be made of the same material. However, in some examples, a relatively more flexible polymer (such as a polymer from the polyimide or PEEK families) may be used to make one or more seal segments used at the radially innermost end of the scroll wall, while a metal is used to make one or more seal segments used towards the radially outermost end of the scroll wall. In either case, using a plurality of seal segments disposed contiguously end to end allows the possibility of providing a tip seal made of materials suitable for pumping environments for which a PTFE tip seal would not be suitable, where it would otherwise be difficult or unduly wasteful of material to use the more suitable material.

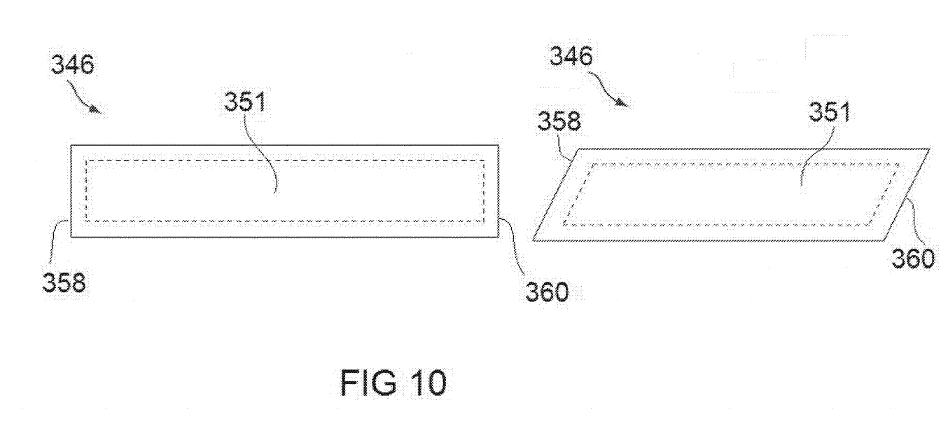

As previously described, the tip seal may be pressed against an opposed major surface of a scroll base plate by fluid disposed between the base of the channel in which the tip seal is housed and the opposing face of the tip seal. The fluid pressure across the tip seal will vary between a relatively lower pressure adjacent the pump inlet and a relatively higher pressure adjacent the pump outlet. In examples in which one or more of the seal segments is made of a metal, it may be desirable to provide voids within the segment, or segments, to reduce the overall density of the seal segment. Otherwise the fluid pressure may be insufficient to press the tip seal against the opposed scroll base plate where the pressure differential across the tip seal is relatively low. Thus, a segmented tip seal may comprise one or more seal segments having a relatively lower density disposed towards the end of the tip seal disposed closest to the pump inlet and one or more seal segments having a relatively higher density disposed towards the end of the tip seal disposed closest to the pump outlet. The overall density of a metal seal segment may be reduced by making the segment from a foamed metal as illustrated by FIG. 9, which would preferably be a closed cell foamed metal defining a plurality of internal voids 251. For example, a solid bronze seal segment may have a density of 8.8 g/cm³ and by using a closed cell foamed bronze seal segment the density may be reduced to 3 to 4 g/cm³. In other examples, a relatively lower density metal seal segment 346 may be made from a cut length of a hollow member, for example a tube, with its ends 358, 360 closed, by for example, suitable crimping or plugging to define internal voids 351 as illustrated by FIG. 10.

The greatest wear to a scroll pump tip seals should occur at the ends of the scroll walls disposed adjacent the pump outlet :26 where the operating pressures should be highest. Providing a segmented tips seal gives rise to the possibility of replacing only those seal segments that are worn sufficiently to require replacement and leaving the remaining seal segments in situ for continued use. This may be both more cost efficient in terms of materials usage and is also more environmentally friendly. Furthermore, having relatively short lengths of new tip seal to wear in following a maintenance operation may be beneficial since the volume of dust produced during wearing in of the tip seal should be reduced.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A scroll pump comprising:
an orbiting scroll;
a fixed scroll; and
a driver configured to impart an orbiting motion to the orbiting scroll relative to the fixed scroll;
wherein said orbiting scroll comprises an orbiting scroll base plate and an orbiting scroll wall extending from said orbiting scroll base plate towards said fixed scroll and said fixed scroll comprises a fixed scroll base plate and a fixed scroll wall extending from said fixed scroll base plate towards said orbiting scroll,
said orbiting scroll wall has a tip face that faces said fixed scroll base plate and said fixed scroll wall has a tip face that faces said orbiting scroll base plate,
said tip face of the orbiting scroll wall is provided with a first tip seal arrangement for sealing between the orbiting scroll wall and the fixed scroll base plate and said tip face of the fixed scroll wall is provided with a second tip seal arrangement for sealing between the fixed scroll wall and the orbiting scroll plate, and
at least one of said first and second tip seal arrangements comprises a plurality of seal segments disposed contiguously end to end on the respective said tip face.

2. The scroll pump as claimed in claim 1, wherein said seal segments each comprise planar end faces and are arranged such that respective opposed said end faces of adjacent said seal segments are in abutting relationship.

3. The scroll pump as claimed in claim 1, wherein said seal segments each comprise end faces and are arranged such that respective opposed said end faces of adjacent said seal segments are disposed in overlapping relationship.

4. The scroll pump as claimed in claim 3, wherein said overlapping end faces are inclined and are disposed in overlying relationship.

5. The scroll pump as claimed in claim 1, wherein said segments each comprise an end provided with an end formation mated with an end formation of an adjacent said seal segment.

6. The scroll pump as claimed in claim 5, wherein said end formations are configured to provide hinged connections between said seal segments.

7. The scroll pump as claimed in claim 5, wherein said end formations comprise projections and mating recesses.

8. The scroll pump as claimed in claim 1, wherein said plurality of seal segments comprises at least one seal segment having a length in the range:
i) 20 to 100 mm; or
ii) 20 to 60 mm.

9. The scroll pump as claimed in claim 8, wherein each said seal segment has a length in at least one of said ranges.

10. A scroll pump as claimed in claim 1, wherein at least one said seal segment is made of a polymer from the:
i) polyimide family;
ii) polyaryletherketone family;
iii) polysulfone family; or
iv) polyamide-imide family.

11. The scroll pump as claimed in claim 1, wherein at least one said seal segment is made of a polymer having a flexural modulus of at least 1.5 GPa, preferably at least 2.0 GPa.

12. The scroll pump as claimed in claim 1, wherein at least one said seal segment is made of a metal.

13. The scroll pump as claimed in claim 1, wherein said plurality of seal segments is disposed in a continuous channel defined in said respective tip face.

14. The scroll pump as claimed in claim 1, wherein said plurality of seal segments comprises at least one first seal segment that has a first density and at least one second seal segment that has a second density, said second density being higher than said first density.

15. A scroll pump tip seal to seal a single stage of a scroll pump that comprises a first scroll and a second scroll, said tip seal comprising a plurality of seal segments to be fitted contiguously end to end to a tip face of a scroll wall of one of said first and second scrolls to form a continuous seal between said tip face and a base plate of the other of said first and second scrolls.

16. The scroll pump tip seal as claimed in claim 15, wherein said seal segments each comprise planar end faces configured to be disposed in abutting face to face relationship when said seal segments are disposed in said contiguous end to end relationship.

17. The scroll pump tip seal as claimed in claim 15, wherein said end faces are configured such that respective opposing said end faces of adjacent said seal segments are disposed in overlapping relationship when said seal segments are disposed in said contiguous end to end relationship.

18. The scroll pump tip seal as claimed in claim 17, wherein said end faces are configured such that said overlapping end faces are in overlying relationship when said seal segments are disposed in said contiguous end to end relationship.

19. The scroll pump tip seal as claimed in claim 15, wherein said seal segments each comprise at least one end provided with an end formation configured to mate with an end formation of an adjacent said seal segment when said seal segments are disposed in said contiguous end to end relationship.

20. The scroll pump tip seal as claimed in claim 19, wherein said end formations are configured to provide a hinged connection between said adjacent seal segments.

21. The scroll pump tip seal as claimed in claim 19, wherein said end formations comprise projections and mating recesses.

22. The scroll pump as claimed in claim 15, wherein said plurality of seal segments comprises at least one seal segment having a length in the range:
i) 20 to 100 mm; or
ii) 20 to 60 mm.

23. The scroll pump tip seal as claimed in claim 22, wherein each said seal segment has a length in at least one of said ranges.

24. The scroll pump tip seal as claimed in claim 15, wherein at least one said seal segment is made of a polymer from the:
i) polyimide family;
ii) polyaryletherketone family
iii) polysulfone family; or
iv) polyamide-imide family.

25. The scroll pump tip seal as claimed in claim 15, wherein at least one said seal segment is made of a polymer having a flexural modulus of at least 1.5 GPa, preferably at least 2.0 GPa.

26. The scroll pump tip seal as claimed in claim 15, wherein at least one said seal segment is made of a metal.

27. The scroll pump tip seal as claimed in claim 15, wherein said plurality of seal segments comprises at least one first seal segment that has a first density and at least one second seal segment that has a second density, said second density being higher than said first density.

28. A method of providing a tip seal in a scroll pump to seal between a tip face of a scroll wall of a first scroll and a base plate of a second scroll, said method comprising disposing a plurality of seal segments contiguously end to end on said tip face to form a continuous said tip seal.

29. The method as claimed in claim 28, comprising disposing said plurality of seal segments such that respective opposed end faces of adjacent said seal segments are in abutting face to face relationship.

30. The method as claimed in claim 29, comprising disposing said plurality of seal segments such that said opposed end faces overlap.

31. The method as claimed in claim 30, wherein said end faces are inclined and comprising disposing said overlapping end faces in overlying relationship.

32. The method as claimed in claim 28, comprising disposing said plurality of seal segments such that respective opposed end formations of adjacent said seal segments mate.

33. The method as claimed in claim 28, comprising disposing said plurality of seal segments such that respective opposed end formations of adjacent said seal segments provide respective hinged connections between said adjacent seal segments.

34. The method as claimed in claim 28, wherein said seal segments are made from:
1) a polymer from the polyimide family;
2) a polymer from the polyaryletherketone family;
3) a polymer from the polysulfone family;
4) a polymer from the polyamide-imide family; or
5) a metal.

35. The method as claimed in claim 28, wherein at least one said seal segment is made of a polymer having a flexural modulus of at least 1.5 GPa, preferably at least 2.0 GPa.

36. The method as claimed in claim 28, wherein said scroll wall has a radially innermost end, a radially outermost end and a length between said ends and said plurality of segments define a tip seal extending from said radially innermost end to a position intermediate said ends.

37. The method as claimed in claim 28, comprising disposing said plurality of seal segments in a continuous channel defined in said tip face.

38. The method as claimed in claim 28, wherein said plurality of seal segments comprises at least one first seal segment that has a first density and at least one second seal segment that has a second density, said second density being higher than said first density.
